(19) United States
(12) Patent Application Publication
(10) Pub. No.: US 2015/0196165 A1
(43) Pub. Date: Jul. 16, 2015

(54) Knife Guided Cutting Board

(71) Applicants: Kwang ho lee, Diamond bar, CA (US); Don Je Lee, Diamond Bar, CA (US)

(72) Inventors: Kwang ho lee, Diamond bar, CA (US); Don Je Lee, Diamond Bar, CA (US)

(73) Assignee: Don Je Lee, Diamond Bar, CA (US)

(21) Appl. No.: 14/153,018

(22) Filed: Jan. 11, 2014

(51) Int. Cl. A47J 47/00; B26B 29/06

(52) U.S. Cl. CPC A47J 47/005; B26B 29/063

(57) ABSTRACT

A knife guided cutting board comprised of a base of a cutting board and a knife guiding device. The half round shape of the knife guide device is the place where the end of the knife will be inserted, so the front side of the knife is firmly stationed when the cutting action is engaged. A knife guided cutting board can cut and slice thick and solid food such as fish, meat, and hard vegetables. The apparatus can work with any conventional knife. The knife guide device will guide the motion of the cutting in a confined downward arc movement due to the fact that the end of the knife is resided in the knife guide device, this ensures consistent and safe cutting is achieved because the force applied by the user is evenly distributed in a upward and downward motion guided by this invention.

### BACKGROUND OF INVENTION

A cutting board is the object used by knife users to cut various types of foodstuffs such as meat, cheese, bread, fish and vegetables. Several types of knives are used in combination with such boards. Users may encounter difficulty when the object being cut is small or hard such as fish, hard vegetables and meat. It is very common for a person to injure him or her while trying to cut hard or small pieces of food with a knife.

The prior art discloses the device where the knife is mounted to the frame. U.S. Pat. No. 4,054,994, provides a fixture for attaching the knife to the board. The front end of the knife is attached to a device that enables the food to be cut by a downward swing of the blade. The blade is attached to the board with components, so if the end user wants to move the blade in the different direction or to a different position, this device will not allow that motion. The fixation of the knife is good as a leverage cutting tool. However, preparing food properly requires various maneuvers in order to do different actions such as cutting, slicing and chopping depending on the different shapes and different solidity of the food object. The knife attached on this cutting board cannot do this job well. In addition to that, this device cannot accommodate the conventional kitchen knife and any prior existing household knifes.

The prior art, U.S. Pat. No. 6,564,685 discloses a specially designed knife where a hole resembling a fish hook is added to the top upper side of the end of knife and can be inserted into three small horizontal metal bars. This enables the user to cut various sizes of food objects by elevating or lowering the position of the cutting knife. In the cutting action, the end user needs to attach the hook on the knife to the metal bar to secure the knife to the tower before any cutting action is taken. Also, if the end user pushes down the knife before it is fully attached to the metal bars, the knife tends to get dislocated from the metal bar, so the knife needs to be held in a stable position with sufficient hand force before any firm contact with the food object. This is not an easy task and does not allow a fast and accurate cutting action required in any food preparation action. In addition to that, this device cannot accommodate the conventional kitchen knife and the existing household knifes.

The prior art, U.S. Pat. No. 8,430,387 discloses a device that can cut various sizes of foodstuff by elevating or lowering the cutting blade position of the elevated tower. This device works well in cutting different food sizes. However, in any realistic cutting action, the knife is in the stationary mode of the tower, so the versatile cutting actions of chopping and slicing are not easily achieved. Also, the blade or the knife needs to be inserted into the hole in the tower, so that it will take some time to engage the knife and tower. In addition to that, this device is a little difficult to accommodate the conventional kitchen knife and the existing household knifes.

### SUMMARY OF INVENTION

In an embodiment of the invention, the knife guide half circle or half circle shape is attached to the cutting board. The end of the knife will be inserted or positioned into the knife guide device which allows any end user to be able to cut any foodstuff with less force and danger. When cutting with a regular cutting board, the knife can be positioned in any direction, so if anyone tries to cut a hard object, the blade can be dislocated or moved in any direction when any wrong force is applied into the object. In normal food preparation, if the food object is not cut in the right position or slips, the sharp blade area can cut the users hand. This is a common situation in everyday kitchen life.

A knife guided cutting board minimizes the blade direction when force is applied because the end of the blade will be resided inside the knife guide device. Also, all possible force is applied to the object because the knife guide device holds the end of the blade in place, getting rid of any wasted force. The handle of the knife is considered the input force when the knife is pushed down, the knife guide device is a temporary fixation of the force point, and the food object laid under the blade is the object to which the force is fully applied. This simple phenomenon can make the cutting easier without any excessive force.

In an embodiment of the invention, the cutting board is made from wood, plastic or any wood metal mixed composite. This will be the base of the cutting to prevent the foodstuffs from contamination due to unwanted items in the area. This should be sturdy and made of any sanitarily safe material.

In another embodiment of the invention, the knife guide device is firmly attached into the cutting board. The end side of the knife guiding device is threaded, so the nut is firmly connected to the cutting board. Usually, two end legs and two nuts are the main components attached to the board. The shape of the knife guide device can be half round, in two different sizes per guide, or in a nipple shape that makes it easy to set the knife into the devices open area. Thus the arc of the movement of the knife by the user is very firm and straight when any cutting is engaged.

This embodiment of the knife guide device is made from metal, stainless steel, or any metal composite that is sanitarily safe. The size of the device and shape can be varied depending on the shape, size and length of the knife.

When any hard cutting action is needed such as cutting meat, hard vegetable, fish and cheese, the user simply inserts the knife into the hole of knife guide device and puts the foodstuffs under the knife blade and performs a cutting action. If it is a larger object, the user can cut using the further side of the knife and gradually scoot it in towards the knife guiding device. If normal slicing or chopping is needed, the knife can be easily removed from the device and do the normal cutting actions.

In summary, this knife guided food cutting board makes it easier to cut hard and large foodstuffs without using an excessive amount of force and does it in a safe and controlled manner, all while being simple to use.

### BRIEF DESCRIPTION OF THE DRAWINGS

The knife guide cutting board apparatus will be easily understood in consideration of the following detailed description of various embodiments with the accompanying drawings, in which:

FIG. 1 is the three exchangeable knife guide devices that can be attached to the cutting board;

FIG. 2 is an overall perspective view of the apparatus;

FIG. 3 is a frontal view of the apparatus;

FIG. 4 is a detailed and cross-sectioned view of the knife guide device;

FIG. 5 is a side view of the apparatus;

FIG. 6 is a top view of the apparatus;

FIG. 7 depicts the metal texture area of the bottom side of the knife guide device; and

FIG. 8 is an overall perspective view of the apparatus according to the invention in use cutting an item (in phantom) of a food object.

### DETAILED DESCRIPTION OF THE DRAWINGS

A knife guided cutting board is a very efficient invention for cutting various food objects. Especially when the food objects are solidified and more dense such as fish with hard bone like salmon, meat, poultry, hard carrot, thick cheese, heavy ham, etc. This invention consists of two major parts. One is the cutting board made of wood or plastic, and the other component is the knife guiding device, which looks like a half circle or similar shape where the tip of the blade can be inserted and guided and resided when the cutting action is engaged. Many common household knives can be used with this invention.

This invention make the cutting task easy by utilizing the force provided by the knife user as a scissor effect where the knife handle and the knife guide device act as a force, and the food under the blade is the same function as the support of the scissor. If there is no knife guide, the force will be diminished from the hand grip to the end of the blade when the force is applied. In normal knife using without anything holding the front side of the knife, the maximum force will be under the right below the handle area, and the minimum or least force will be at the tip of the blade. This will result in less or inefficient cutting occurring at the front side of the knife. In contrast, this knife guide cutting board provides the user a way to apply all available force into the food object under the blade due to the fact that the force will be fully applied to the object because the knife guide device will act as something holding the front side of the knife, allowing all available force to be put into the object.

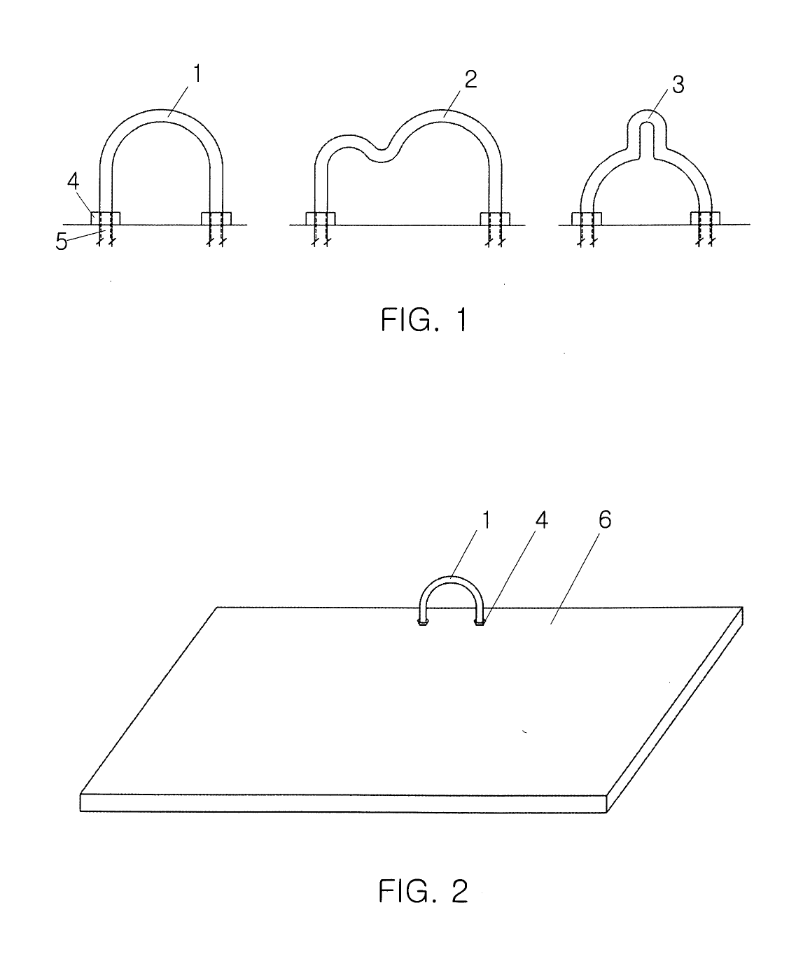

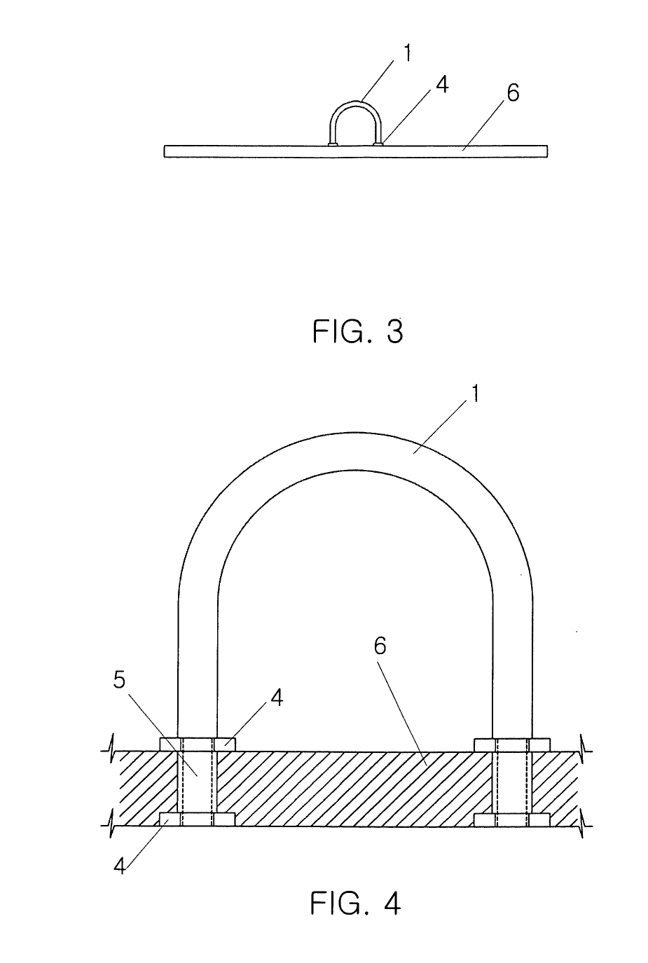

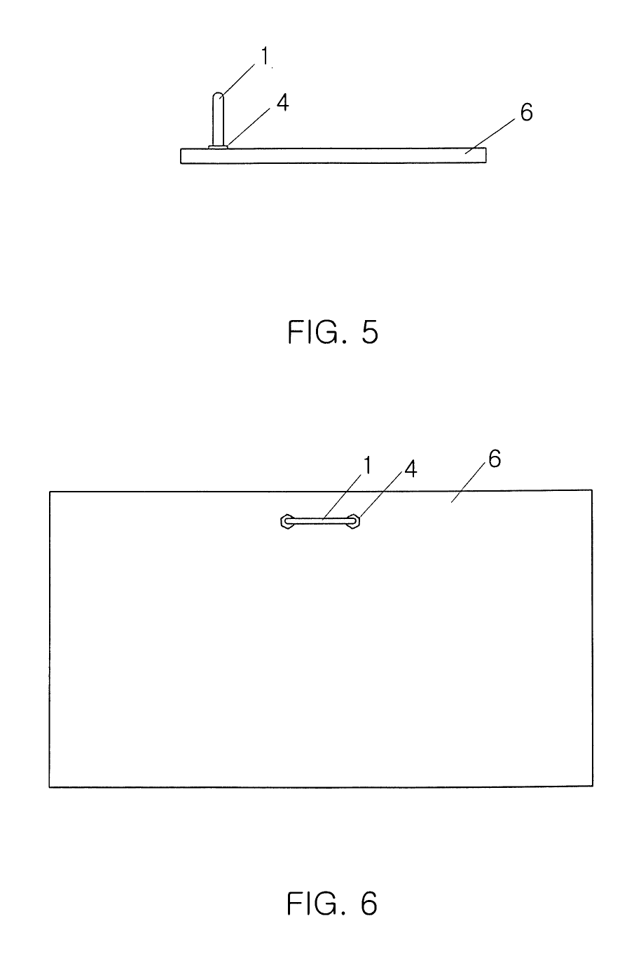

FIG. 1 shows three exchangeable knife guide devices. The prototype half round circle device 1 is most useful for the common cutting action. The second item 2 has two different sizes of half circles to accommodate for different sizes of knife blades. The third knife guide device 3 has a nipple shape extruding area on top of the device. This area can be the place where the knife can be inserted most firmly, and when force is applied from the hand to the cutting board, the knife can be well stabilized and straightened.

FIG. 2 is an overall perspective view of the invention. This device is designed for simplicity as well as effectiveness, and has only one component without counting four small nuts to hold the device. The front side of the knife can be inserted into the opening area of the knife guide device and set the food object under the knife to be cut. FIG. 4 is an enlarged cross-sectioned drawing of the knife guide device. Four nuts 4 will be used to secure the cutting board to the half round circle device 1. The two legs of the device are threaded 5 for the nut joint.

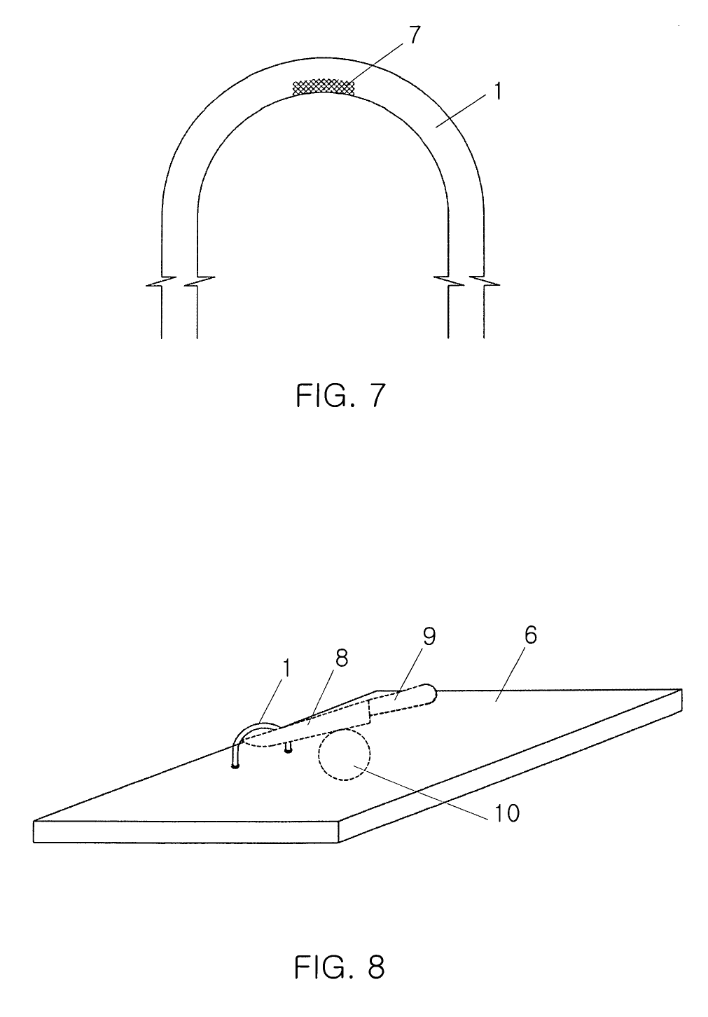

FIG. 7 depicts a zoomed in view, showing the grated metal texture area 7 beneath the top of the device. Many knives in this day are made from metal, most commonly stainless steel. Stainless steel tends to be very shiny and slippery because it is made of very strong and dense metal composites, causing the surface of the stainless knife to have no friction. The metal texture enables strong contact and holds the contact area between the device and the top side of the front knife when the cutting action is occurring.

FIG. 8 depicts the invention in action. The food object 10 is resided under the blade 8 and the cutting force is applied by the knife grip 9. The end of the knife is in contact with the knife guide device 1. When the knife user pushes down on the knife handle 9, the full force is applied to the cutting object 10 without losing any force because the device 1 provides a something to hold the front of the knife, causing maximum force. The knife also can be removed as to the knife user's need in any time anywhere without any disengagement procedure. Also because there is no knife fixation device such as a screw or hook in the device, the knife movement will be very much versatile. If there is no knife holding or guide component such as a normal cutting board, force will only be applied to the area of the knife right next to the handle, and the area touching the foodstuffs. There is less force applied if the foodstuffs are further away from the handle. However, this knife guide cutting board works in the opposite way and is much more efficient. If the distance from the grip to the food is far, more force will be applied because the length of the knife will act as a leverage force, more distance means more force. Therefore if the food object is resided in any blade area, the total force will always be more than the initial force, In contrary, if there is no knife guide device holding the knife, the cutting force will always be less than the initial force when the actual cutting is engaged. Although the present invention has been described in considerable detail with reference to certain preferred versions thereof, other versions are possible. Therefore, the spirit and scope of the appended claims should not be limited to the description of the preferred versions contained therein.

The invention claimed is:

1. A knife guided cutting board comprising: a cutting board that serves as a base which is the first surface made of wood or plastic to receive an article that is to be sliced or cut; a knife guide device made of metal on the board where the user places the end of the knife and can be inserted when the cutting action is engaged.

2. The knife guided cutting board according to claim 1, wherein said the half circle shape of the knife guide device can be attached vertically with threaded nuts to the base of the cutting board without any spring or moving parts.

3. The knife guided cutting board according to claim 1, wherein said the knife guide device is exchangeable with different opening area sizes or a nipple shaped ones for different guiding of the knife.

4. The knife guided cutting board according to claim 1, wherein said the knife guide device will hold and set the position of the end side of the knife in the knife guide device that confines the horizontal and arc movement of the knife by the user.
